(19) United States
(12) Patent Application Publication
(10) Pub. No.: US 2009/0112764 A1
(43) Pub. Date: Apr. 30, 2009

(54) METHOD AND SYSTEM FOR PROVIDING FINANCIAL SECURITY IN A 1031 EXCHANGE

(76) Inventor: CECILY A. DRUCKER, Mill Valley, CA (US)

Correspondence Address: PERKINS COIE LLP, P.O. BOX 1208, SEATTLE, WA, 98111-1208, US

(21) Appl. No.: 12/259,237

(22) Filed: Oct. 27, 2008

Related U.S. Application Data
(60) Provisional application No. 60/983,118, filed on Oct. 26, 2007.

(51) Int. Cl. G06Q 40/00

(52) U.S. Cl. 705/42; 705/35; 705/39

(57) ABSTRACT

Systems and methods of financial security system for a 1031 exchange are discussed to address security concerns that exchange proceeds may be misappropriated without the authorization of the taxpayer client by implementing authorization and verification processes. The 1031 exchange begins with a specific taxpayer client (TP) when the Qualified Intermediary (QI) and TP sign an exchange agreement and the QI assigns a specific Exchange File Number (EFN) tied to the bank's identification number of a sub-account for the exchange. The QI notifies the system of the EFN and TP's email address. The system encodes a security device with EFN (and TP's email address in one embodiment), which is sent to TP. Then TP can log on to create a password using the received security device. This password is used to provide added security in the process of authorization and verification by TP of incoming and outgoing funds.

### CROSS REFERENCE TO RELATED APPLICATIONS

This application claims the benefit of priority to U.S. Provisional Patent Application Ser. No. 60/983,118, filed Oct. 26, 2007, entitled “Method and System for Providing Financial Security in a 1031 Exchange” by Cecily Drucker, Attorney Docket No.: 66514-8001.US00, which application is hereby incorporated by reference.

### FIELD OF INVENTION

This invention relates to the field of financial security for a 1031 exchange based on Section 1031 of the U.S. Internal Revenue Code that allows investors to defer capital gain taxes on the exchange of like-kind properties.

### BACKGROUND OF THE INVENTION

A 1031 Exchange is a transaction under United States Internal Revenue Code Section 1031. Section 1031 specifies that if an asset is sold and the proceeds of the sale are then reinvested in a like kind asset, no gain or loss is recognized. This allows deferment of capital gain taxes that would otherwise have been due on the first sale.

1031 exchanges can be used by any taxpayer who is selling property “held for investment or used in its trade or business”. Section 1031 allows a taxpayer client (TP) to reinvest all equity from the sold property in the newly purchased property while deferring any capital gains taxes, subject to certain conditions.

The use of a “Qualified Intermediary (QI)” provides a “safe harbor” (presumption that the Section 1031 exchange is valid and will be allowed) for the transaction. The QI must be an entity who is “independent”, and, to ensure financial security, should be a bonded and insured corporation that engages in no other business.

A QI is treated as a “principal” in the transaction, and is deemed to be the “seller” of the taxpayer's old property (called the “Relinquished Property”) and will receive the taxpayer's net equity (the “Exchange Proceeds”) when the Relinquished Property is sold to the buyer. When the taxpayer has identified and is ready to purchase the new property (called the “Replacement Property”), the QI is treated, for tax purposes, as the buyer and will disburse the Exchange Proceeds on behalf of the taxpayer to purchase the Replacement Property.

Although the QI is treated as a ‘principal’ for tax purposes, the QI does not take title to either property, does not negotiate the sale or purchase agreements, does not qualify for or obtain any financing, or otherwise become involved in the non-exchange aspects of either the sale of the Relinquished Property, or the purchase of the Replacement Property.

However, since the QI holds the taxpayer's net equity (the “Exchange Proceeds”) received when the Relinquished Property is sold to the buyer, there are security concerns that the QI may misappropriate or embezzle the exchange proceeds. While the QI may be a bonded and insured corporation that engages in any other business, there remain security concerns. A need exists to ensure security of a taxpayer client's funds while in the possession of the QI.

### BRIEF DESCRIPTION OF THE DRAWINGS

FIG. 1 illustrates the interacting parties in a 1031 exchange in one embodiment of the security system.

FIG. 2 depicts a flow diagram illustrating the process of a security system for a 1031 exchange according to one embodiment.

FIG. 3 depicts a flow diagram illustrating the process of controlling interest by a security system for a 1031 exchange according to one embodiment.

FIG. 4 depicts a system providing security protection for a 1031 exchange according to one embodiment.

### DETAILED DESCRIPTION OF EMBODIMENTS OF THE INVENTION

A method and system provide verification and security in processing a 1031 exchange. The 1031 exchange may involve four parties: a security system, a taxpayer client, a bank, and a qualified intermediary. The provided method and system allow the taxpayer client to verify and authorize transactions from a bank sub-account at the bank, thereby improving security and preventing misappropriation of exchange proceeds by the qualified intermediary.

The security system may be added to 1031 exchange transactions to monitor the qualified intermediary and provide the taxpayer client with verification and authorization over any deposits or disbursements from a bank sub-account associated with the 1031 exchange. An exchange file number is associated with each 1031 exchange, a sub-account, a taxpayer client, a relinquished property, and a replacement property when found. The taxpayer client may access the security system via the Internet to verify proceeds from the sale of the relinquished property have been deposited into the sub-account. The taxpayer client may also access the security system to authorize a disbursement from the sub-account to purchase the replacement property.

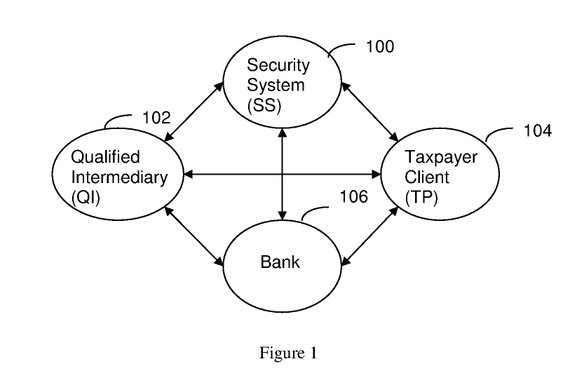

FIG. 1 illustrates the interacting parties in a 1031 exchange in one embodiment of the presented security system. A security system 100 (SS) may be a computer system or other system set in place to allow a taxpayer client 104 to verify and monitor the proceeds from a 1031 exchange among the remaining parties. The security system 100 may communicate with a qualified intermediary 102 and a bank 106 to monitor funds related to a 1031 exchange as proceeds are received and disbursed. The security system 100 may provide access to a taxpayer client 104

A qualified intermediary 102 (QI) may be an independent corporation in the full-time business of facilitating 1031 exchanges for a taxpayer client, as discussed above.

A taxpayer client 104 (TP) may be an individual or legal person seeking to accomplish a 1031 exchange, as discussed above.

A bank 106 may be a financial institution holding accounts and sub-accounts for the qualified intermediary on behalf of the taxpayer client 104. Each 1031 exchange in the system may be associated with a sub-account. The qualified intermediary 102 may establish a relationship with the taxpayer client 104 through an exchange agreement, which is associated with the sub-account information. Thus, each 1031 exchange is associated with a unique sub-account at the bank 106.

Proceeds from a 1031 exchange sale of a relinquished property are placed into an associated sub-account. Proceeds from the sale are disbursed from the associated sub-account upon authorization by the taxpayer client for purchase of a replacement property.

The security system 100, the qualified intermediary 102, the taxpayer client 104 and the bank 106 may communicate over a combination of networks, such as the Internet or private networks. Other communication channels may also be utilized. The taxpayer client 104 may then monitor the balance of a sub-account associated with a 1031 exchange and authorize any disbursements from the sub-account.

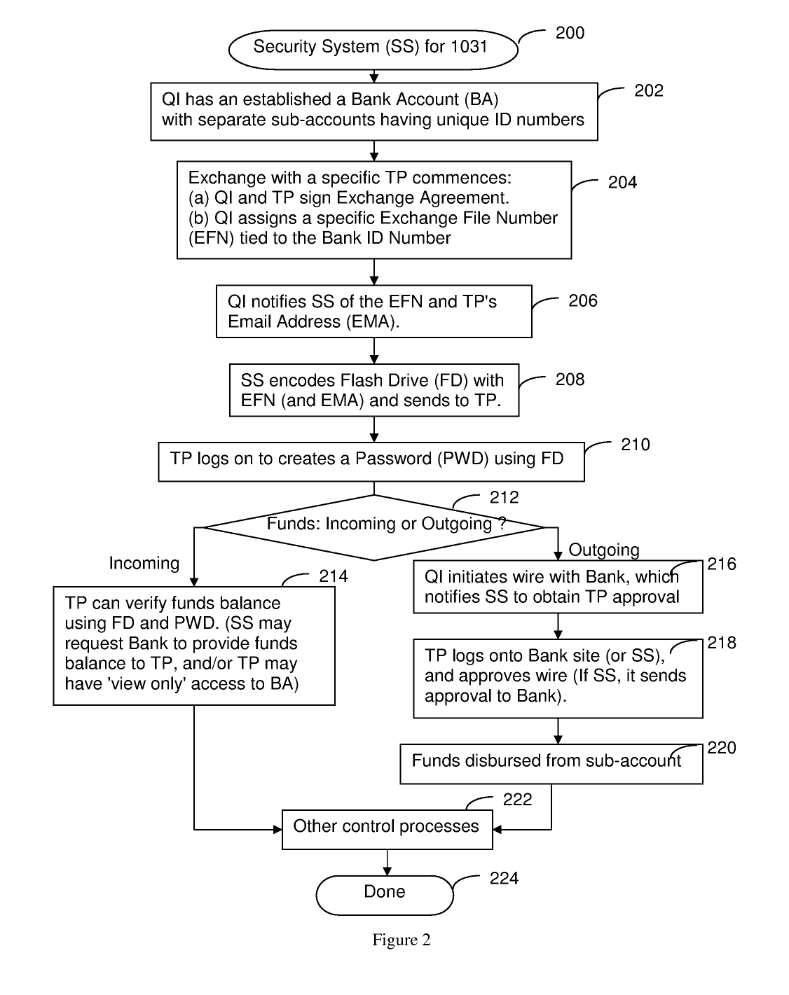

FIG. 2 depicts a flow diagram illustrating the process of a security system for a 1031 exchange according to one embodiment. In the Security System (SS, or the system) for 1031 exchange 200, the Qualified Intermediary (QI) has established or creates a bank account with separate sub-accounts having unique ID numbers 202. The 1031 exchange begins with a specific Taxpayer client (TP) when the QI and TP sign an exchange agreement and the QI assigns a specific Exchange File Number (EFN) tied to the bank identification number of a sub-account for the exchange 204.

The QI notifies the system (SS) of the EFN and TP's email address 206. The system encodes a security device, e.g. a Flash Drive (FD) with EFN (and email address in another embodiment), which is sent to TP to provide security protection 208. Then TP can log on to create a password using the received FD 210. This password is used to provide added security in the process of authorization and verification by TP. It is important to understand that other security mechanisms beside a flash drive could be used, e.g. a token device for generating a token, a memory device storing the security information, a CD or other non-volatile storage medium that stores account and/or password information. The present invention is not limited to the exemplary embodiments discussed in this disclosure. It will be evident that various modifications may be made thereto without departing from the broader spirit and scope as set forth in the claims.

Depending on whether the funds are incoming or outgoing to and from the bank account in the process of 1031 exchange 212, there are two separate processes (214 and 216). When the funds are incoming to the bank account, TP can verify funds balance using the FD 214 sent by the system and the password set up by TP. In one embodiment, SS may request the bank to provide funds balance to TP, or TP may have a ‘view only’ access to the bank account in another embodiment.

When the funds are outgoing from the bank account, QI initiates the process of wiring the funds with the bank, which notifies SS to obtain TP's approval 216. Upon notification, SS and TP can log onto the bank site and approve the wiring the funds using FD (or other security device) and the password. Or in another embodiment, TP can request the system to send approval to the bank 218.

After receiving the authorization or approval, the bank disburses funds from the sub-account of the 1031 exchange 220. This completes the process for outgoing funds. However, there could be other control processes added to the system for other aspects of 1031 exchange.

For example, there are other accounting issues including interest payments on the funds held in the sub-account. Because of tax issues, it is not desirable for TP to disburse the funds' interest prematurely. To help the control of the interest, QI and SS may want to control interest, collect fees, and do the accounting properly.

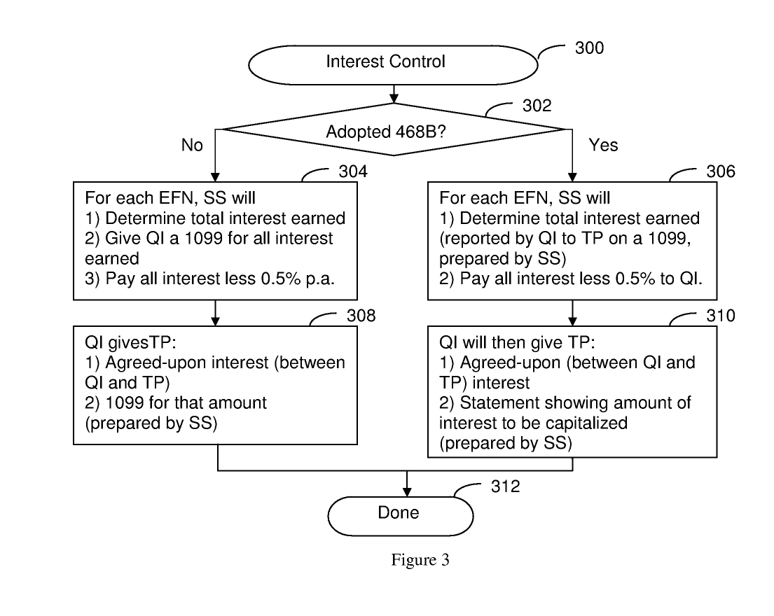

FIG. 3 depicts a flow diagram illustrating a procedure for controlling interest payments by a security system for a 1031 exchange. In 300, the system is tasked with controlling interest payments in a 1031 exchange in order to comply with relevant laws and regulations.

In 302, the procedure may test whether a proposed change to Internal Revenue Code Section 468B has been adopted. A proposed change requires ‘all’ interest be reported as income to TP (and net funds retained by QI and 1031 SS must be capitalized). If no, the procedure proceeds to 304. If yes, the procedure proceeds to 306.

In 304, the SS will, for each EFN, 1) determine the total interest earned for the assigned EFN, 2) give QI a 1099 for all interest earned for that EFN, and 3) pay all interest less 0.5% p.a.; e.g., the rate earned by QI will be 0.5% less than the rate earned on the account.

In 308, the QI will give TP the agreed upon interest between QI and TP, and the 1099 tax document for that amount, prepared by SS.

In 306, SS will, for each EFN,: 1) determine the total interest earned for that EFN (this must be reported by QI to TP on a 1099 form prepared by SS, and 2) pay all interest less 0.5% to QI.

In 310, the QI will give TP the agreed upon interest between QI and TP and a statement showing the amount of interest which has to be capitalized, which is prepared by SS.

In 312, the procedure ends.

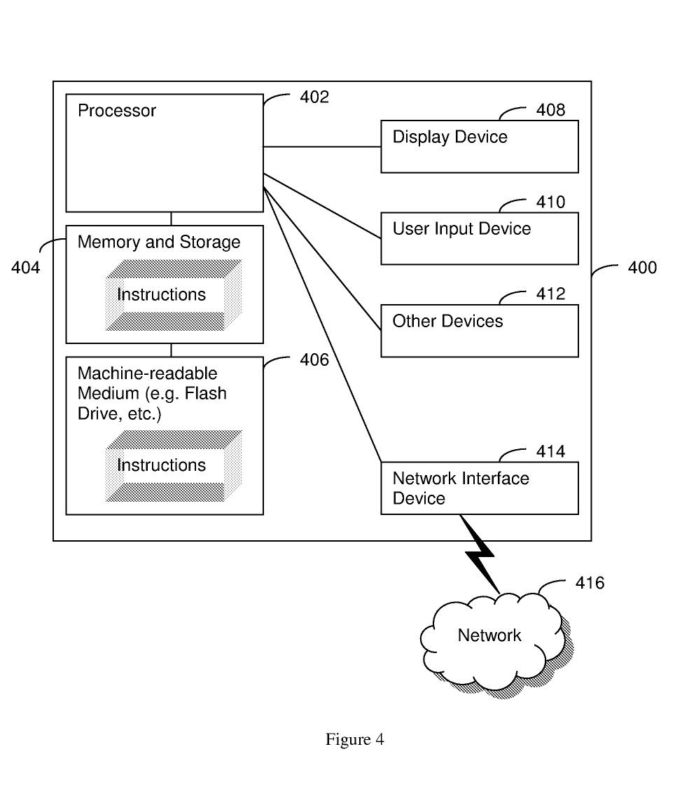

FIG. 4 depicts a system providing security protection for one or more 1031 exchanges according to one embodiment. One embodiment of the security system 400 includes a processor 402 configured to execute computer-readable instructions to carry out the security procedures and functionality discussed above.

The system 400 may include a memory and storage 404 necessary for processing and storing information related to the 1031 exchange. For example, memory 404 may be locally accessible to the processor 402, and may be volatile or non-volatile rewritable memory configured to store digital information.

The system 400 may include a removable machine readable medium 406 storing confidential information of the TP related to the 1031 exchange. For example, the removable medium 406 may be a flash drive (FD) configured to store encoded information of the EFN associated with the 1031 exchange. Further, the encoded information to FD may include TP's email address.

The system 400 may include a display device 408 for displaying information to a system user. The system 400 may include a user input device 410 to receive inputs from a system user. The system user may be an administrator at the security system responsible for setting up, administrating and monitoring the system 400.

The system 400 may include other devices 412, such as standard or non-standard peripherals.

The system 400 may include a network interface device 414 to connect the system with a network 416 for communication and information access. The network 416 may be any network configured to carry digital information. The system 400 may communicate with a bank's computer, a QI's computer, or a taxpayer client over the network 416. Communications over the network 416 may be encrypted or otherwise protected.

An example embodiment of the present invention may be a method for providing a secure 1031 exchange using a security system. The method may include assigning a specific exchange file number tied to a bank identification number of a sub-account for the exchange by a qualified intermediary after the qualified intermediary and a taxpayer client execute an exchange agreement. The method may include notifying to the security system of the exchange file number and the taxpayer client's email address by the qualified intermediary. The method may include encoding a security device by the security system with the exchange file number. The method may include providing the security device with the exchange file number to the taxpayer client. The method may include creating a password by the taxpayer using the received security device to log onto the security system. The method may include using the security device and password to authorize and verify related transactions in the exchange by the taxpayer client. The security device may be a flash drive. The encoding may further include encoding an email address of the taxpayer on the security device. The step of using the security device and password is applied to verify the balance of an incoming funds balance. The method may include requesting by the taxpayer for the bank to provide the balance. The method may include providing the taxpayer with a ‘view only’ access to the bank account to verify the balance of incoming funds. The method may include initiating a process of wiring the funds in the bank by the qualified intermediary. The method may include notifying the security system to obtain the taxpayer client's approval by the qualified intermediary. The method may include logging onto the bank site by the taxpayer using the security device and password. The method may include approving the wiring of the funds by the taxpayer using the security device and password. The method may include disbursing funds by the bank from the sub-account of the exchange. The method may include requesting by the taxpayer client for the security system to send the taxpayer client's approval to the bank. The method may include calculating the total interest earned for the assigned exchange file number by the security system. The method may include providing the qualified intermediary with a 1099 tax document for all interest earned for that the exchange file number by the security system. The method may include paying all interest less 0.5% to the qualified intermediary by the security system. The method may include giving the taxpayer client by the qualified intermediary an agreed upon interest between the qualified intermediary and the taxpayer client and the 1099 tax document prepared by the security system for that amount. The method may include calculating the total interest earned for that the exchange file number by the security system. The method may include providing the taxpayer client with a 1099 tax form for the total interest by the qualified intermediary. The method may include paying all interest less 0.5% to the qualified intermediary by the security system. The method may include giving the taxpayer client by the qualified intermediary an agreed upon interest between the qualified intermediary and the taxpayer client and a statement prepared by the security system showing the amount of interest which has to be capitalized.

Another embodiment of the present invention may be a method for providing a secure 1031 exchange with a security system. The method may include receiving an exchange file number from a qualified intermediary after the qualified intermediary and a taxpayer client execute an exchange agreement and the qualified intermediary assign an exchange file number associated with a bank sub-account to a pending 1031 exchange. The method may include encoding a removable medium with the exchange file number. The method may include providing the removable medium to the taxpayer client. The method may include responsive to a log on attempt by the taxpayer client, requesting a password from the taxpayer client. The method may include responsive to a taxpayer client's request after log on, display past 1031 exchange transactions or authorize pending 1031 exchange transactions. The removable medium may be a flash drive. The removable medium may be further encoded with a taxpayer client's email address. A past 1031 exchange transaction may be a deposit into the sub-account from a 1031 exchange sale. A pending 1031 exchange transaction may be a disbursement from the sub-account to complete a 1031 exchange purchase. The method may include calculating an interest earned for the assigned exchange file number. The method may include providing the qualified intermediary with a 1099 tax document for the interest earned. The method may include paying the interest earned less a commission to the qualified intermediary. The method may include disbursing a remaining interest earned to the taxpayer client. The method may include calculating an interest earned for the assigned exchange file number. The method may include providing the taxpayer client with a 1099 tax form for the interest earned. The method may include paying the interest earned less a commission to the qualified intermediary. The method may include giving the taxpayer client by the qualified intermediary an agreed upon interest between disbursing a remaining interest earned to the taxpayer client and providing a statement showing an amount of interest earned that must be capitalized. The method may include receiving a taxpayer client's email address. The method may include assigning, by a qualified intermediary, an exchange file number associated with a bank sub-account to a pending 1031 exchange after the qualified intermediary and the taxpayer client execute an exchange agreement. The method may include notifying the security system of the exchange file number and the taxpayer client's email address by the qualified intermediary. The method may include receiving notification of deposit pursuant to a 1031 exchange sale to the sub-account. The method may include receiving notification of disbursing funds after a 1031 exchange purchase from the sub-account. The method may include receiving, by the qualified intermediary, a 1099 tax document after an interest earned for the assigned exchange file number is calculated by the security system. The method may include receiving, by the qualified intermediary, the interest earned less a commission. The method may include providing by the qualified intermediary for the taxpayer client with a 1099 tax form, based on calculations of an interest earned for the assigned exchange file number by the security system. The method may include responsive to receiving the interest earned less a commission from the security system, disbursing by the qualified intermediary to the taxpayer client an agreed upon interest between the qualified intermediary and the taxpayer client. The method may include providing by the qualified intermediary for the taxpayer client a statement that is prepared by the security system, showing an amount of interest earned that must be capitalized.

Another example embodiment of the present invention may be a security system for a 1031 exchange. The system may include a processor. The system may include a memory to store information. The system may include a machine readable medium that stores encoded information of an exchange file number assigned for the 1031 exchange. The system may include a network interface device to connect the security system to a network for communication with a qualified intermediary, a taxpayer client, and a bank. The system may include instructions for encoding the machine readable medium with the exchange file number by the security system and creating a password for the taxpayer client. The system may include means for using the machine readable medium and password for authorization and verification of incoming and outgoing funds of the exchange through the bank. The machine readable medium may be a flash drive. Instruction for encoding the machine readable medium may further include instructions for encoding an email address of the taxpayer client.

Another example embodiment of the present invention may be a security system for a 1031 exchange. The system may include means for assigning and storing a specific exchange file number tied to a bank identification number of a sub-account for the exchange by a qualified intermediary after the qualified intermediary and a taxpayer client signed an exchange agreement. The system may include means for notifying to the security system of the exchange file number and the taxpayer client's email address by the qualified intermediary. The system may include means for encoding a security device by the security system with the exchange file number. The system may include means for sending the security device with the exchange file number to the taxpayer client. The system may include means for creating a password by the taxpayer client using the received security device to log onto the security system. The system may include means for using the security device and password to improve security for taxpayer client by authorizing and verifying related transactions in the exchange. The security device may be a flash drive.

Although the above embodiments have been discussed with reference to specific example embodiments, it will be evident that the various modification, combinations and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method for providing a secure 1031 exchange using a security system, comprising:
assigning an exchange file number associated with a sub-account for the exchange by a qualified intermediary after the qualified intermediary and a taxpayer client execute an exchange agreement;
notifying the security system of the exchange file number and a taxpayer client email address by the qualified intermediary;
encoding a security device by the security system with the exchange file number;
providing the security device with the exchange file number to the taxpayer client;
creating a password by the taxpayer using the received security device to log onto the security system; and
using the security device and password to authorize and verify related transactions in the exchange by the taxpayer client.

2. The method of claim 1, wherein the security device is a flash drive encoded with the taxpayer client email address.

3. The method of claim 2, wherein the flash drive and password are used to verify an incoming deposit.

4. The method of claim 1, wherein the related transactions in the exchange include: viewing a current balance, authorizing an outgoing fund transfer, and verifying an incoming fund transfer.

5. The method of claim 4, wherein authorizing the outgoing fund transfer further comprises:
initiating a wire transfer by the qualified intermediary;
notifying the security system to obtain a taxpayer client approval by the qualified intermediary;
logging onto a bank site by the taxpayer client using the security device and password;
approving the wire transfer by the taxpayer client using the security device and password; and
disbursing funds by the bank from the sub-account of the exchange.

6. The method of claim 5, wherein approving the wire transfer further comprises:
requesting by the taxpayer client for the security system to send the taxpayer client approval to the bank.

7. The method of claim 1, further comprising:
calculating an earned interest for the exchange file number by the security system;
providing the qualified intermediary with a 1099 tax document for the earned interest of the exchange file number by the security system;
paying all earned interest less a commission to the qualified intermediary by the security system; and
giving the taxpayer client by the qualified intermediary an agreed upon interest amount and the 1099 tax document prepared by the security system for that amount.

8. The method of claim 1, further comprising:
calculating an earned interest for the exchange file number by the security system;
providing the taxpayer client with a 1099 tax form for the earned interest by the qualified intermediary;
paying all earned interest less a commission to the qualified intermediary by the security system; and
giving the taxpayer client by the qualified intermediary an agreed upon interest amount and a statement prepared by the security system showing an amount of interest to be capitalized.

9. A method for providing a secure 1031 exchange with a security system, comprising:
receiving an exchange file number from a qualified intermediary after the qualified intermediary and a taxpayer client execute an exchange agreement and the qualified intermediary assigns an exchange file number associated with a bank sub-account to a pending 1031 exchange;
encoding a removable medium with the exchange file number;
providing the removable medium to the taxpayer client;
responsive to a subsequent log on attempt by the taxpayer client, requesting a password from the taxpayer client; and
responsive to a taxpayer client request after log on, displaying past 1031 exchange transactions or authorizing pending 1031 exchange transactions.

10. The method of claim 9, wherein the removable medium is a flash drive encoded with a taxpayer client email address.

11. The method of claim 10, wherein the flash drive and password are used to verify an incoming deposit.

12. The method of claim 9, wherein a past 1031 exchange transaction is a deposit into the sub-account from a 1031 exchange sale of a relinquished property.

13. The method of claim 9, wherein a pending 1031 exchange transaction is a disbursement from the sub-account to complete a 1031 exchange purchase of a replacement property.

14. The method of claim 9, further comprising:
calculating an earned interest for the assigned exchange file number;
providing the qualified intermediary with a 1099 tax document for the earned interest;
paying the earned interest less a commission to the qualified intermediary; and
disbursing a remaining earned interest to the taxpayer client.

15. The method of claim 9, further comprising:
calculating an earned interest for the assigned exchange file number;
providing the taxpayer client with a 1099 tax form for the earned interest;
paying the earned interest less a commission to the qualified intermediary; and
giving the taxpayer client by the qualified intermediary an agreed upon interest and providing a statement showing an amount of interest to be capitalized.

16. The method of claim 9, wherein the related transactions in the exchange include: viewing a current balance and verifying an incoming fund transfer.

17. A security system for a 1031 exchange, comprising:
a processor;
a memory to store information;
a machine readable medium configured to store encoded information of an exchange file number assigned for the 1031 exchange;
a network interface device to connect the security system to a network for communication with a qualified intermediary, a taxpayer client, and a bank;
instructions for encoding the machine readable medium with the exchange file number by the security system and creating a password for the taxpayer client;
means for using the machine readable medium and password for authorization and verification of incoming and outgoing funds of the exchange through the bank.

18. The system of claim 17, wherein the machine readable medium is a flash drive.

19. The system of claim 18, wherein the flash drive is encoded with a taxpayer client email address.

20. The system of claim 17, wherein instruction for encoding the machine readable medium further includes instructions for encoding a taxpayer client email address.
